(19) United States
(12) Patent Application Publication
(10) Pub. No.: US 2026/0152396 A1
(43) Pub. Date: Jun. 4, 2026

(54) 2D MULTICOLOR RARE EARTH CHALCOPHOSPHATE EMITTER AND METHODS MAKING AND USING SAME

(71) Applicant: Government of the United States, as a represented by the Secretary of the Air Force, Wright-Patterson AFB, OH (US)

(72) Inventors: Michael Susner, Kettering, OH (US); Rahul Rao, Yellow Springs, OH (US); Jonathan Goldstein, Cincinnati, OH (US); Emmanuel Rowe, Nashville, TN (US); Ryan Siebenaller, Columbus, OH (US); Ryan Selhorst, Dayton, OH (US); Andrea Giordano, Dayton, OH (US)

(21) Appl. No.: 18/976,505

(22) Filed: Dec. 11, 2024

Related U.S. Application Data
(60) Provisional application No. 63/609,427, filed on Dec. 13, 2023.

(51) Int. Cl. C01B 19/00; C09K 11/88; G01N 21/64

(52) U.S. Cl. CPC C01B 19/002; C09K 11/886; G01N 21/6428; C01P 2002/54; C01P 2002/77; C01P 2006/60; G01N 2021/6432

(57) ABSTRACT

The present invention relates to 2D multicolor rare earth chalcophosphate emitter and methods making and using same. The present invention relates to 2D multicolor rare earth chalcophosphate emitter and methods making and using same. Devices containing 2D multicolor rare earth chalcophosphates such as erbium containing crystals that have a high intensity, focused emission spectra that has minimal scattering and quenching of photoluminescence. In addition, an improved process for making rare earth chalcophosphates, such as erbium containing crystals, wherein dried metal halide powders are used is provided.

### CROSS-REFERENCE TO RELATED APPLICATION

The present application claims priority to U.S. Provisional Application Ser. No. 63/609,427 filed Dec. 13, 2023, the contents of all such priority documents being hereby incorporated by reference in their entry.

### RIGHTS OF THE GOVERNMENT

The invention described herein may be manufactured and used by or for the Government of the United States for all governmental purposes without the payment of any royalty.

### FIELD OF THE INVENTION

The present invention relates to 2D multicolor rare earth chalcophosphate emitter and methods making and using same.

### BACKGROUND OF THE INVENTION

Devices using two dimensional materials that are doped with erbium have excessively wide emission spectra, a lack of emission intensity and suffer from defects such as agglomerated erbium ions and vacant sites that can cause emission scattering and quenching of photoluminescence.

Applicants recognized that the source of the aforementioned problem was that, in doped materials, erbium is nonuniformly distributed. Thus, Applicants disclose devices containing a replacement material, erbium containing crystals, wherein the erbium atoms are uniformly distributed and locked within a lattice structure having specific crystalline positions. As a result, such erbium crystals have a high intensity, focused emission spectra that has minimal scattering and quenching of photoluminescence.

Finally, current methods of making erbium containing crystals, such as AgErP₂Se₆, are limited to a maximum processing temperature of about 650° C. because the decomposition temperature of such crystals is from about 650° C. to 700° C. Thus, the reaction rates of such processes is limited. In order to solve the aforementioned problem, previous researchers have employed metal powders as reactants. Unfortunately, such metal powders are susceptible to oxide contamination that results in the inhibition of the growth of the final crystal phase. Here, Applicants disclose an improved process for making rare earth chalcophosphates, such as erbium containing crystals wherein dried metal halide powders are used. Such powders are not susceptible to oxide contamination thus high reaction rates can be obtained at even lower temperatures than normally used and complete final crystal phase formation is obtained. In addition, when the metal halide powders decompose during the crystal making process, free halides are liberated and such free halides further improve crystal growth as such free halides serve as a vapor transport agent for the crystal's precursor atoms. Such an integrated halide decomposition approach avoids the multiple steps that are required when halide materials are introduced independently in a crystal making process.

### SUMMARY

The present invention relates to 2D multicolor rare earth chalcophosphate emitter and methods making and using same. Devices containing 2D multicolor rare earth chalcophosphates such as erbium containing crystals that have a high intensity, focused emission spectra that has minimal scattering and quenching of photoluminescence. In addition, an improved process for making rare earth chalcophosphates, such as erbium containing crystals, wherein dried metal halide powders are used is provided.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a fabrication process for AgErP₂Se₆, showing 1 an evacuated quartz ampoule containing precursor powders 2, the heated evacuated quartz ampoule 3, containing crystals 4 made from said precursor powders, additional crystals 5 made from said precursor powders, ripened and enlarged crystals 7 made from said precursor powders, additional ripened and enlarged crystals 9 made from said precursor powders and 8 evacuated, cooled quartz ampoule after approximately 100 hours of heating.

FIG. 2A depicts a view of an internal structural representation of AgErP₂Se₆ crystals 1 along crystallographic axis “a” 2, comprising selenium atoms 3, phosphorous atoms 4, erbium atoms 5, and silver atoms 6.

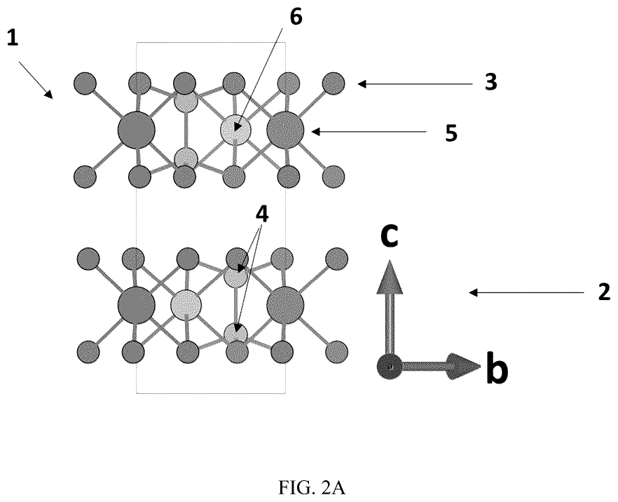

FIG. 2B depicts a view of an internal structural representation of AgErP₂Se₆ crystals 1 along crystallographic axis “b” 2, comprising selenium atoms 3, phosphorous atoms 4, silver atoms 5, and erbium atoms 6.

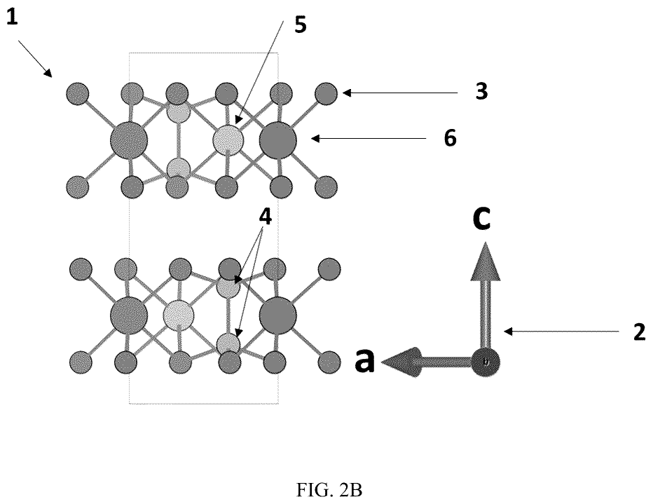

FIG. 2C depicts a view of an internal structural representation of AgErP₂Se₆ crystals 1 along crystallographic axis “c” 2, comprising selenium atoms 3, phosphorous atoms 4, silver atoms 5, and erbium atoms 6.

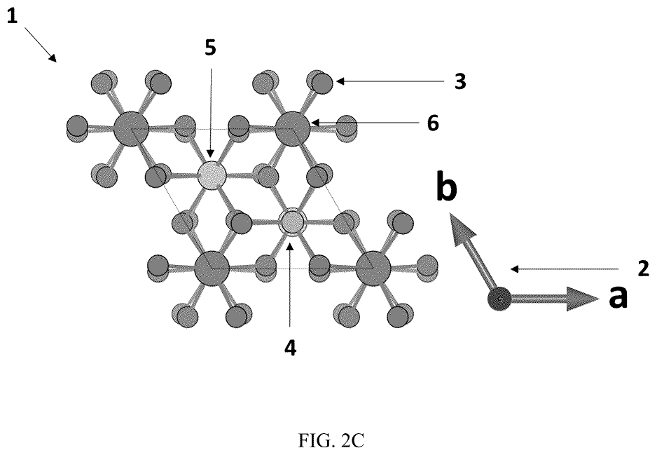

FIG. 2D depicts an isometric view of an internal structural representation of AgErP₂Se₆ crystals 1 along axis 2, comprising selenium atoms 3, phosphorous atoms 4, silver atoms 5, and erbium atoms 6.

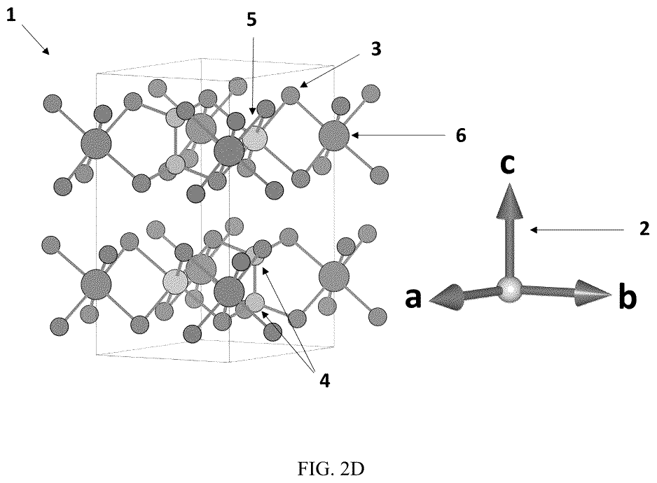

FIG. 3A depicts photoluminescence emission at approximately 660 nm from AgErP₂Se₆ crystals at approximately 298K using an excitation wavelength of 514.5 nm.

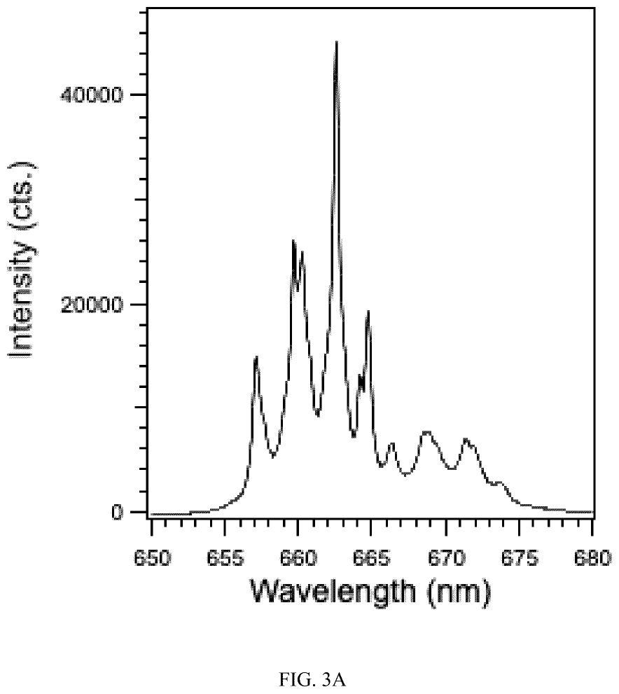

FIG. 3B depicts photoluminescence emission at approximately 810 nm from AgErP₂Se₆ crystals at approximately 298K using an excitation wavelength of 514.5 nm.

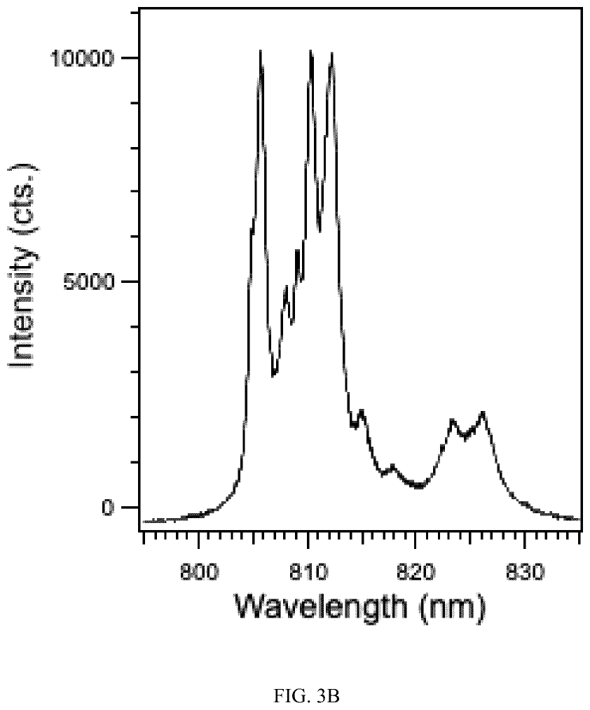

FIG. 3C depicts photoluminescence emission at approximately 980 nm from AgErP₂Se₆ crystals at approximately 298K using an excitation wavelength of 514.5 nm.

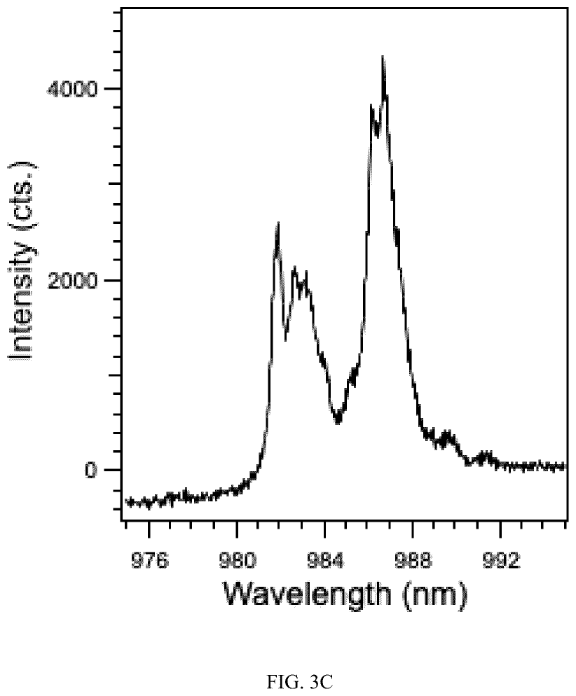

FIG. 3D depicts photoluminescence emission at approximately 1550 nm from AgErP₂Se₆ crystals at approximately 298K using an excitation wavelength of 1064 nm.

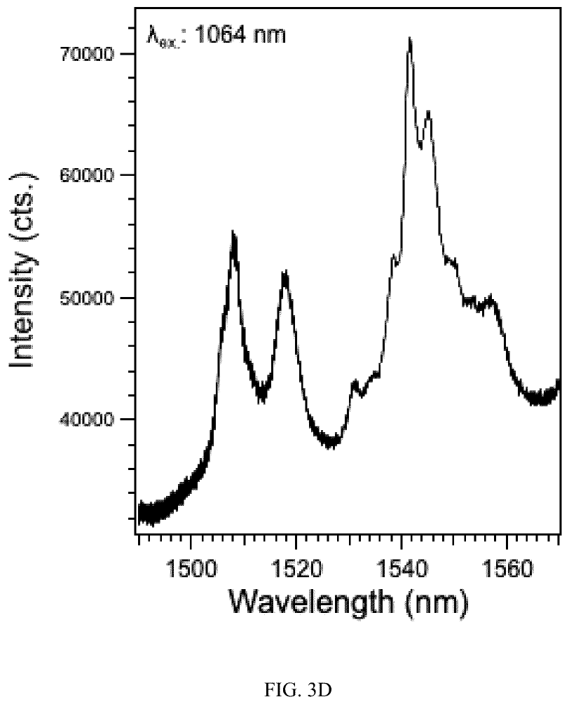

FIG. 4 depicts temperature dependent photoluminescence emission from AgErP₂Se₆ crystals displaying a peak at approximately 550 nm below a temperature of 200K.

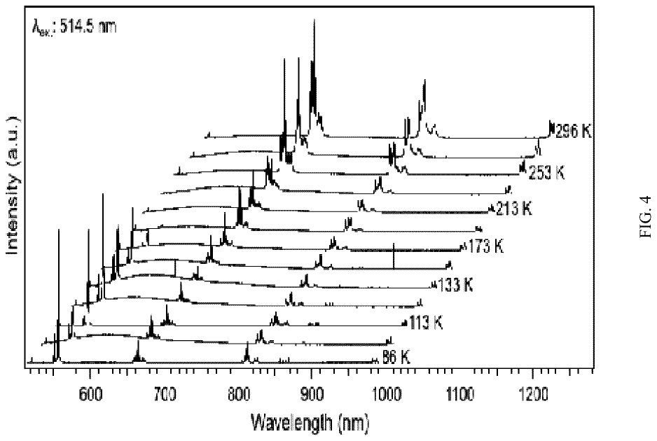

FIG. 5A depicts temperature dependent photoluminescence emission from 11 nm thick AgErP₂Se₆ crystals.

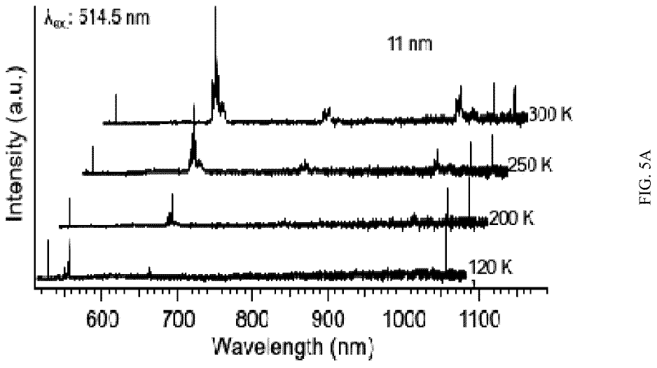

FIG. 5B depicts temperature dependent photoluminescence emission from 51 nm thick AgErP₂Se₆ crystals.

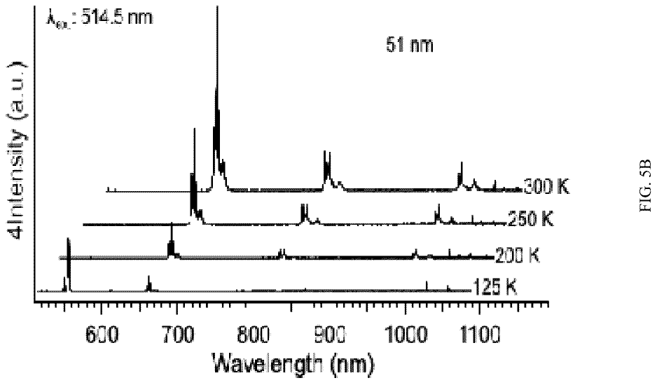

FIG. 5C depicts temperature dependent photoluminescence emission from 220 nm thick AgErP₂Se₆ crystals.

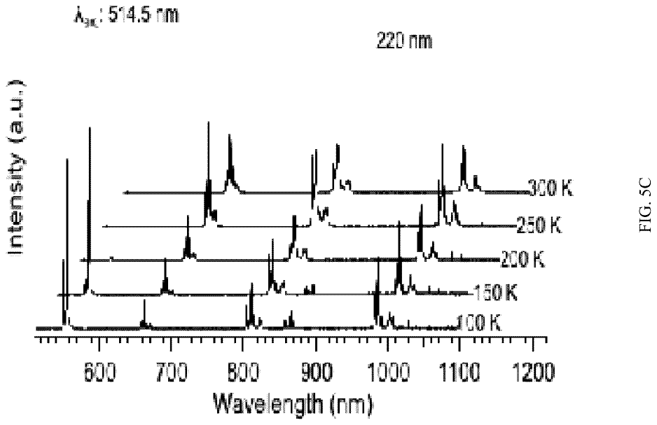

FIG. 6 depicts the lifetime of photoluminescence emission at 660 nm and a temperature of 298K from AgErP₂Se₆ crystals.

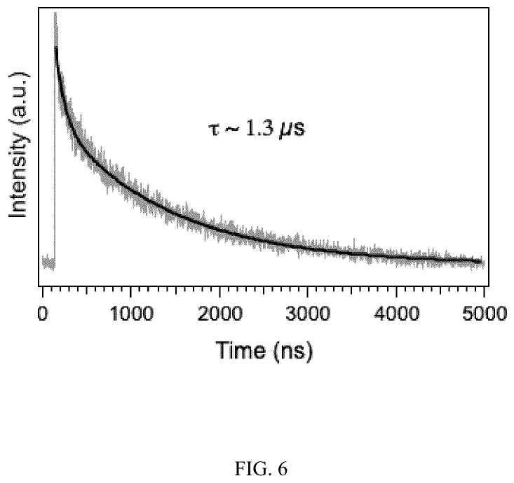

FIG. 7 depicts the emission from a Yb doped AgErP₂Se₆ crystal at a temperature of 298K. The arrow in FIG. 7 shows the emission peak as a result of the Yb dopant.

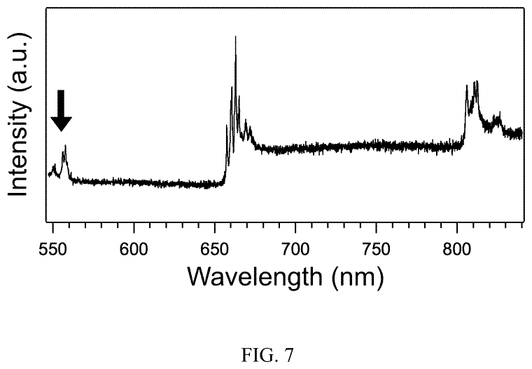

FIG. 8 depicts the quenching of emission from AgErP₂Se₆ crystals as a function of dimethyl methylphosphonate concentration.

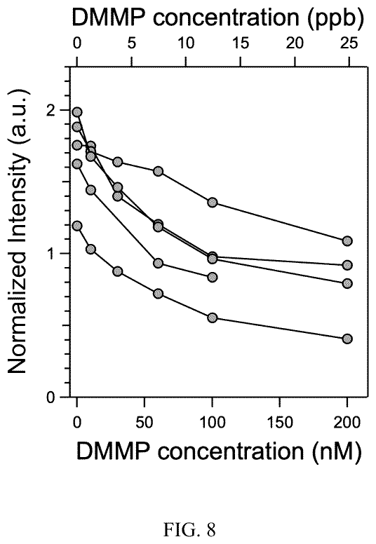

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### 2D Multicolor Rare Earth Chalcophosphate Emitter and Articles Comprising Same

For purposes of this specification, headings are not considered paragraphs. The individual number of each paragraph above and below this paragraph can be determined by reference to this paragraph. In this paragraph, Applicants disclose a device comprising one or more AgErP₂Se₆ crystals, said one or more AgErP₂Se₆ crystals being two dimensional, said one or more AgErP₂Se₆ crystals having an emission bandwidth of from about 0.1 nm to about 0.5 nm at 298K for an emission peak of about 660 nanometers, having an emission bandwidth of from about 0.1 nm to about 0.5 nm at 298K for an emission peak of about 810 nanometers, having an emission bandwidth of from about 0.1 nm to about 0.5 nm at 298K for an emission peak of about 980 nanometers and/or having an emission bandwidth of from about 0.1 nm to about 0.5 nm at 298K for an emission peak of about 1550 nanometers; preferably said one or more AgErP₂Se₆ crystals having an emission bandwidth of from about 0.1 nm to about 0.4 nm at 298K for an emission peak of about 660 nanometers, said one or more AgErP₂Se₆ crystals having an emission bandwidth of from about 0.1 nm to about 0.4 nm at 298K for an emission peak of about 810 nanometers, said one or more AgErP₂Se₆ crystals having an emission bandwidth of from about 0.1 nm to about 0.4 nm at 298K for an emission peak of about 980 nanometers and/or said one or more AgErP₂Se₆ crystals having an emission bandwidth of from about 0.1 nm to about 0.4 nm at 298K for an emission peak of about 1550 nanometers; more preferably said one or more AgErP₂Se₆ crystals having an emission bandwidth of from about 0.1 nm to about 0.3 nm at 298K for an emission peak of about 660 nanometers, said one or more AgErP₂Se₆ crystals having an emission bandwidth of from about 0.1 nm to about 0.3 nm at 298K for an emission peak of about 810 nanometers, said one or more A AgErP₂Se₆ crystals having an emission bandwidth of from about 0.1 nm to about 0.3 nm at 298K for an emission peak of about 980 nanometers and/or said one or more AgErP₂Se₆ crystals having an emission bandwidth of from about 0.1 nm to about 0.3 nm at 298K for an emission peak of about 1550 nanometers; most preferably said one or more AgErP₂Se₆ crystals having an emission bandwidth of from about 0.1 nm to about 0.2 nm at 298K for an emission peak of about 660 nanometers, said one or more AgErP₂Se₆ crystals having an emission bandwidth of from about 0.1 nm to about 0.2 nm at 298K for an emission peak of about 810 nanometers, said one or more AgErP₂Se₆ crystals having an emission bandwidth of from about 0.1 nm to about 0.2 nm at 298K for an emission peak of about 980 nanometers and/or said one or more AgErP₂Se₆ crystals having an emission bandwidth of from about 0.1 nm to about 0.2 nm at 298K for an emission peak of about 1550 nanometers; said device being a light emitting diode, optical fiber, gas sensor, particle sensor, temperature sensor, force sensor, magnetic sensor, or optical signal processor. Applicants note that said one or more AgErP₂Se₆ crystals can have one, two, three or all four of the recited emission bandwidths at the recited emission peaks.

In this paragraph, Applicants disclose the device of the previous paragraph wherein said AgErP₂Se₆ crystals are doped with a maximum of 10 atomic percent Yb, preferably said AgErP₂Se₆ crystals are doped with 0.1 atomic percent to 10 atomic percent Yb, said doped AgErP₂Se₆ crystals having a photoluminescence emission peaks between 540 and 565 nm at 298K.

In this paragraph, Applicants disclose an article comprising the device of the previous two paragraphs, said article being an aerospace vehicle, a motor vehicle, a water vehicle, a computer, a weapon system, a wireless device, an environmental sensor or a biomedical device. In one aspect, said environmental sensor can be used to detect pressure, temperature, biological warfare agents and/or chemical warfare agents.

TABLE 1
Aerospace Vehicle Types and Modes of Guidance, Navigation,
and Control That Can Comprise Applicants' Device

| | | |
|---|---|---|
| Vehicle | GNC Methods | Maneuver Method |

AIR

| | | |
|---|---|---|
| Weather Balloon | radiosonde, theodolite | pressure inside balloon |
| Manned aircraft | altimeter, inertial navigation system | thrust, flight control |
| | (INS), Global Positioning System (GPS) | surfaces |
| Unmanned aircraft | altimeter, INS, GPS | thrust, flight control |
| | | surfaces |
| Quadcopter | visual sensor, GPS | propeller(s) |
| Airborne Missile | altimeter, INS, GPS | thrust, flight control |
| | | surfaces |

AEROSPACE

| | | |
|---|---|---|
| Scientific Balloon | star camera, altimeter | pressure inside balloon |
| Sounding Rocket | ring laser gyro, altimeter, accelerometers | thrust, flight control |
| | | surfaces |
| Space Shuttle | human-in-the-loop, star camera | thrust, flight control |
| | | surfaces |
| Launch Vehicle | INS, ring laser gyro, altimeter, | thrust, flight control |
| (Rocket) | accelerometers | surfaces |
| Ballistic Missile | INS, GPS | thrust, flight control |
| | | surfaces |

SPACE

| | | |
|---|---|---|
| Satellite | star camera, sun sensor, horizon sensor, | thruster, electric propulsion, |
| | GPS | magnetorquer, momentum |
| | | wheel |
| Space Station | human, star camera, sun sensor, horizon | thruster, electric propulsion, |
| | sensor, GPS | magnetorquer, momentum |
| | | wheel |
| Interplanetary | star camera, sun sensor | thruster, electric propulsion, |
| Vehicle | | momentum wheel |

Examples of Flight Control Surfaces: Fins, Ailerons, Elevators.
Thrust includes the two-directional thrust force, as well as any gimbaled thrust vectoring the vehicle is capable of generating.

### Process of Making

In this paragraph, Applicants disclose a process of making a 2D multicolor rare earth chalcophosphate crystal comprising:
a) placing raw materials in ampoule comprising quartz, said raw materials being AgBr, Er, P and Se in a molar ratio of about 1:1:2:6 to about 1:1:2.5:7; or AgBr, ErBr₃, P and Se in a molar ratio of about 1:1:2:6 to about 1:1:2.5:7; preferably said ampoule is a quartz ampoule; The ampoule should be sized to fit within the hot zone of the furnace that will be used to heat the ampoule and the ampoule should have sufficient head space to allow for vapor expansion within the ampoule without failure of the ampoule. The ampoule should be a clean ampoule. The ampoule can be cleaned by acid-etching, then rinsing with high-purity water, and then thoroughly dried prior to synthesis.
b) evacuating the ampoule and then flushing the ampoule with an inert noble gas; preferably the ampoule is evacuated and flushed with an inert gas at least two, three, four five, or even six times; preferably said inert gas is Ar; preferably said ampoule is evacuated to a pressure of about 7 m Torr to about 30 mTorr, in one aspect 20 mTorr or less. The ampoule is typically evacuated by placing it on a vacuum manifold line, and pumped, slowly at first so as not to disturb the powder, until the base pressure reached approximately 20 mTorr. The ampoule is typically then flushed 3-6 times with high purity Ar gas to eliminate any residual contamination.
c) sealing the ampoule under vacuum, preferably the ampoule is sealed by heating the ampoule;
d) heating the sealed ampoule to a temperature of from about 550° C. to about 620° C. at a rate of at least 1° C. per hour until said temperature is achieved and holding the ampoule at said temperature for a time of about 50 hrs to about 300 hrs, preferably said ampoule is heated to a temperature of from about 580° C. to about 620° C. at a rate of about 20° C. to about 40° C. per hour until said temperature is achieved and the holding the ampoule said temperature for about 72 hrs to about 120 hrs;
e) cooling the ampoule, preferably said ampoule is cooled to a temperature of from about 20° C. to about 40° C., preferably said cooling is conducted at the same rate as the heating step of step d); The cooling step allows for easier handling of the ampoule.
f) scoring the ampoule and removing the contents of said ampoule. Said scoring can be conducted using a diamond blade.

In this paragraph, Applicants disclose process of making a doped 2D multicolor rare earth chalcophosphate crystal comprising:
a) placing raw materials in ampoule comprising quartz, said raw materials being AgBr, Er, Yb, P and Se in a molar ratio of about 1:0.9:0.1:2:6 to about 1:0.9:0.1:2.5:7; or AgBr, Er powder, YbCl₃, P and Se in a molar ratio of about 1:0.9:0.1:2:6 to about 1:0.9:0.1:2.5:7; preferably said ampoule is a quartz ampoule. The ampoule should be sized to fit within the hot zone of the furnace that will be used to heat the ampoule and the ampoule should have sufficient head space to allow for vapor expansion within the ampoule without failure of the ampoule. The ampoule should be a clean ampoule. The ampoule can be cleaned by acid-etching, then rinsing with high-purity water, and then thoroughly dried prior to synthesis.
b) evacuating the ampoule and then flushing the ampoule with an inert noble gas; preferably the ampoule is evacuated and flushed with an inert gas at least two, three, four five, or even six times; preferably said inert gas is Ar; preferably said ampoule is evacuated to a pressure of about 7 mTorr to about 30 mTorr, in one aspect, 20 mTorr or less. The ampoule is typically evacuated by placing it on a vacuum manifold line, and pumped, slowly at first so as not to disturb the powder, until the base pressure reached approximately 20 mTorr. The ampoule is typically then flushed 3-6 times with high purity Ar gas to eliminate any residual contamination.
c) sealing the ampoule under vacuum, preferably the ampoule is sealed by heating the ampoule;
d) heating the sealed ampoule to a temperature of from about 580° C. to about 680° C. at a rate of at least 1° C. per hour until said temperature is achieved and holding the ampoule at said temperature for a time of about 50 hrs to about 300 hrs, preferably said ampoule is heated to a temperature of from about 600° C. to about 660° C. at a rate of about 20° C. to about 40° C. per hour until said temperature is achieved and the holding the ampoule said temperature for about 72 hrs to about 120 hrs;
e) cooling the ampoule, preferably said ampoule is cooled to a temperature of from about 20° C. to about 40° C., preferably said cooling is conducted at the same rate as the heating step of step d); The cooling step allows for easier handling of the ampoule.
f) scoring the ampoule and removing the contents of said ampoule. Said scoring can be conducted using a diamond blade.

### Methods of Use

In this paragraph, Applicants disclose a method of detecting the presence of one or more chemical agents of interest, said method comprising:
a) placing one or more AgErP₂Se₆ crystals having an emission bandwidth of from about 0.1 nm to about 0.5 nm at 298K for an emission peak of about 660 nanometers, preferably said one or more AgErP₂Se₆ crystals having an emission bandwidth of from about 0.1 nm to about 0.4 nm at 298K for an emission peak of about 660 nanometers, more preferably said one or more AgErP₂Se₆ crystals having an emission bandwidth of from about 0.1 nm to about 0.3 nm at 298K for an emission peak of about 660 nanometers, most preferably said one or more AgErP₂Se₆ crystals having an emission bandwidth of from about 0.1 nm to about 0.2 nm at 298K for an emission peak of about 660 nanometers, in a region wherein said one or more chemical agents of interest maybe present and measuring the quenching of said one or more AgErP₂Se₆ crystals' emission; and/or
b) placing one or more AgErP₂Se₆ crystals, said AgErP₂Se₆ crystals being doped with a maximum of 10 atomic percent Yb, preferably said AgErP₂Se₆ crystals are doped with 0.1 atomic percent to 10 atomic percent Yb, said v crystals having an emission bandwidth of from about 0.1 nm to about 0.5 nm at 298K and a photoluminescence emission peaks between 540 and 565 nm at 298K, preferably said one or more AgErP₂Se₆ crystals have an emission bandwidth of from about 0.1 nm to about 0.4 nm at 298K and a photoluminescence emission peaks between 540 and 565 nm at 298K, more preferably said one or more AgErP₂Se₆ crystals have an emission bandwidth of from about 0.1 nm to about 0.3 nm at 298K and a photoluminescence emission peaks between 540 and 565 nm at 298K, most preferably said one or more AgErP₂Se₆ crystals having an emission bandwidth of from about 0.1 nm to about 0.2 nm at 298K and a photoluminescence emission peaks between 540 and 565 nm at 298K, in a region wherein said one or more chemical agents of interest maybe present and measuring the quenching of said one or more AgErP₂Se crystals' emission.

In this paragraph, Applicants disclose the method of the previous paragraph wherein said quenching of said one or more AgErP₂Se₆ crystals' emission is compared to a quenching of emission database for said one or more AgErP₂Se₆ crystals. This method yields the quantity of said one or more chemical agents of interest that are present in said region; and/or said quenching of said one or more Yb doped AgErP₂Se₆ crystals' emission is compared to a quenching of emission database for said one or more Yb doped AgErP₂Se₆ crystals.

In this paragraph, Applicants disclose the method of the previous two paragraphs wherein said one or more chemical agents of interest are selected from the group consisting of dimethyl methylphosphonate, 2-chloroethyl ethyl sulfide, methyl salicylate, diethyl malonate, ethyl lactate, malathion, 1,3-dichloropropane, sarin, S-{2-[Di(propan-2-yl)amino]ethyl} O-ethyl methylphosphonothioate, a sulfur mustard, ethyl dimethylphosphoramidocyanidate, a Novichok agent, O-pinacolyl methylphosphonofluoridate and mixtures thereof.

### Test Methods for Measuring Emission Spectra

For purposes of this specification, the emission spectra of crystals are measured as follows:
a) Test Set-up For Temperatures
   (i) for a temperature range of 293K to 305K load the crystal to be tested under an objective lens (50×) in an optical spectrometer (such as a Renishaw in Via Raman microspectrometer)
   (ii) for the temperature-dependent measurements from 85 K to 292K and 306K to 873K, a freshly cleaved crystal is placed into a hot/cold cell (e.g. Mikroptik or Linkam Scientific), the cell is pumped down to a base pressure of 100 mTorr using a rough vacuum pump, and cooled down to 85 K using an attached liquid nitrogen pump; and
   (iii) for the temperature-dependent measurements between 84K and 6 K, a freshly cleaved crystal is placed into a hot/cold cryostat (Advanced Research Systems), the cell is pumped down to a base pressure of 100 mTorr using a rough vacuum pump, and cooled down to 6 K using a closed cycle helium pump
b) focus on the crystal to be tested collecting photoluminescence spectra;
c) excite the crystal to be tested by exposing said crystal to a laser beam from a laser system having a power of 500 μW for a time duration of 1 s;
   (i) for measuring emission at wavelengths ranging from 540-980 nm, use a laser excitation wavelength of 514.5 or 488 nm, and
   (ii) for measuring emission at a wavelength of 1550 nm, using a laser excitation wavelength of 1064 nm;
d) record the spectra from the crystal to be tested.

### EXAMPLES

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### Example 1

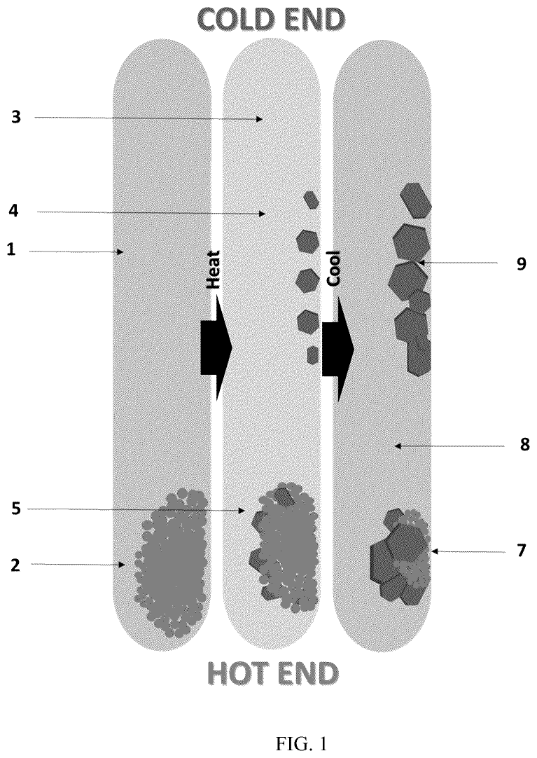

AgErP₂Se₆ was synthesized using the following method. The compounds/elements are combined in a fused silica (quartz) ampoule using the following stoichiometric relationship: AgBr+Er+2P+6Se→AgErP₂Se₆+½Br₂. For a 2 g batch, this will imply 0.4631 g AgBr, 0.4125 g Er, 0.1528 g P, and 1.1686 g Se. We additionally add 20% excess by weight of P. In this technique, the AgBr disassociates at high temperature and provides free Br₂ to act as a mineralizer/vapor transport agent. This metal-salt dissolution technique was further extended to the use of rare earth (RE) salts to help with the reaction of the reagents to form the final compound. For example, dry ErX₃ where X=F, Cl, Br, or I will allow for both 1) homogeneous distribution of the RE element for the reaction and 2) the presence of additional vapor transport agent to help drive the reaction forward and promote crystal growth and is unique to our procedure. The ampoule, 5-6″ long, 18 cm diameter, was evacuated to a base pressure of ˜20 mTorr and flushed several times with Ar gas to eliminate any trace atmospheric gasses. The ampoule was then placed in a standard small tube furnace (Thermcraft or Lindberg) such that the charge (i.e. the mixture of precursor elements/compounds) was near the thermocouple at the center of the apparatus. The crystals tended to form at the cold end and were thus easily isolated. We subjected the ampoule to the following heat-treatment schedule: 30 hrs of heating at a constant rate until 600° C. was reached followed by a 100 h hold and a cooldown at the same rate as heating (FIG. 1). The resultant crystals were ˜2 mm×2 mm in area and ˜0.25 mm thick.

### Example 2—Detailed AgErP₂Se₆ Synthesis

a) Preparation of 5-6″ long, 18 cm diameter quartz ampoule whereby the interior is acid-etched, rinsed with high-purity water, and thoroughly dried prior to synthesis b) weighing of the precursor powders for either of the following reactions (both have been successful): AgBr+Er+2P+6Se→AgErP₂Se₆+½Br₂OR AgBr+ErBr₃+2P+6Se→AgErP₂Se₆+2Br₂. In either case, excess P is used to help drive the reaction forward to completion. Typical excess amounts of P are 10-20%. The weighing of the powders was performed in a glovebox to ensure that moisture contamination would not be an issue. Typical batch sizes were approximately 2 g total.
c) The sample was placed on a vacuum manifold line and pumped down, slowly at first so as not to disturb the powder, until the base pressure reached approximately 20 mTorr. The ampoule was then flushed 3-6 times with high purity Ar gas to eliminate any residual contamination.
d) The sample was sealed under vacuum, allowed to cool, and placed in a standard tube furnace with a 1″ diameter and 30 cm heated zone. The end of the sample with the precursor powders was placed at the thermocouple location which is the hottest location of this type of furnace.
e) The furnace was slowly ramped to 600° C. at a rate of 30° C. per hour until a temperature of 600° C. is achieved. The ampoule is then held at this temperature for approximately 100 hrs followed by a cooling step at the same rate as the heating step.
f) The ampoule was removed from the furnace and scored using a diamond blade. The material was extracted from the opened ampoule, left to air out any residual bromine for several hours, and then packaged in membrane boxes for storage and ready access for characterization.

Every document cited herein, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A device comprising one or more AgErP₂Se₆ crystals, said one or more AgErP₂Se crystals being two dimensional, said one or more AgErP₂Se₆ crystals having an emission bandwidth of from about 0.1 nm to about 0.5 nm at 298K for an emission peak of about 660 nanometers, having an emission bandwidth of from about 0.1 nm to about 0.5 nm at 298K for an emission peak of about 810 nanometers, having an emission bandwidth of from about 0.1 nm to about 0.5 nm at 298K for an emission peak of about 980 nanometers and/or having an emission bandwidth of from about 0.1 nm to about 0.5 nm at 298K for an emission peak of about 1550 nanometers; said device being a light emitting diode, optical fiber, gas sensor, particle sensor, temperature sensor, force sensor, magnetic sensor or optical signal processor.

2. The device of claim 1, wherein said one or more AgErP₂Se₆ crystals having an emission bandwidth of from about 0.1 nm to about 0.4 nm at 298K for an emission peak of about 660 nanometers, said one or more AgErP₂Se₆ crystals having an emission bandwidth of from about 0.1 nm to about 0.4 nm at 298K for an emission peak of about 810 nanometers, said one or more AgErP₂Se₆ crystals having an emission bandwidth of from about 0.1 nm to about 0.4 nm at 298K for an emission peak of about 980 nanometers and/or said one or more AgErP₂Se₆ crystals having an emission bandwidth of from about 0.1 nm to about 0.4 nm at 298K for an emission peak of about 1550 nanometers.

3. The device of claim 2, wherein said one or more AgErP₂Se₆ crystals having an emission bandwidth of from about 0.1 nm to about 0.3 nm at 298K for an emission peak of about 660 nanometers, said one or more AgErP₂Se₆ crystals having an emission bandwidth of from about 0.1 nm to about 0.3 nm at 298K for an emission peak of about 810 nanometers, said one or more AgErP₂Se₆ crystals having an emission bandwidth of from about 0.1 nm to about 0.3 nm at 298K for an emission peak of about 980 nanometers and/or said one or more AgErP₂Se₆ crystals having an emission bandwidth of from about 0.1 nm to about 0.3 nm at 298K for an emission peak of about 1550 nanometers.

4. The device of claim 3, wherein said one or more AgErP₂Se₆ crystals having an emission bandwidth of from about 0.1 nm to about 0.2 nm at 298K for an emission peak of about 660 nanometers, said one or more AgErP₂Se₆ crystals having an emission bandwidth of from about 0.1 nm to about 0.2 nm at 298K for an emission peak of about 810 nanometers, said one or more AgErP₂Se₆ crystals having an emission bandwidth of from about 0.1 nm to about 0.2 nm at 298K for an emission peak of about 980 nanometers and/or said one or more AgErP₂Se₆ crystals having an emission bandwidth of from about 0.1 nm to about 0.2 nm at 298K for an emission peak of about 1550 nanometers,

5. The device of claim 1, wherein said one or more AgErP₂Se₆ crystals can have one, two, three or all four of the recited emission bandwidths at the recited emission peaks.

6. The device of claim 1 wherein said AgErP₂Se₆ crystals are doped with a maximum of 10 atomic percent Yb.

7. The device of claim 6 wherein said AgErP₂Se₆ crystals are doped with 0.1 atomic percent to 10 atomic percent Yb, said doped AgErP₂Se₆ crystals having a photoluminescence emission peaks between 540 and 565 nm at 298K.

8. An article comprising the device of claim 1, said article being an aerospace vehicle, a motor vehicle, a water vehicle, a computer, a weapon system, a wireless device, an environmental sensor or a biomedical device.

9. A process of making a 2D multicolor rare earth chalcophosphate crystal comprising:
a) placing raw materials in ampoule comprising quartz, said raw materials being
(i) AgBr, Er, P and Se in a molar ratio of about 1:1:2:6 to about 1:1:2.5:7; or
(ii) AgBr, ErBr₃, P and Se in a molar ratio of about 1:1:2:6 to about 1:1:2.5:7;
b) evacuate the ampoule and then flush the ampoule with an inert noble gas;
c) sealing the ampoule under vacuum;
d) heating the sealed ampoule to a temperature of from about 550° C. to about 620° C. at a rate of at least 1° C. per hour until said temperature is achieved and holding the ampoule at said temperature for a time of about 50 hrs to about 300 hrs;
e) cooling the ampoule; and
f) scoring the ampoule and removing the contents of said ampoule.

10. The process of claim 9 wherein:
a) said ampoule is a quartz ampoule;
b) said ampoule is evacuated and flushed with an inert gas at least two, three, four five, or even six times; said ampoule is evacuated to a pressure of about 7 mTorr to about 30 mTorr;
c) said ampoule is sealed by heating the ampoule;
d) said ampoule is heated to a temperature of from about 580° C. to about 620° C. at a rate of about 20° C. to about 40° C. per hour until said temperature is achieved and the holding the ampoule said temperature for about 72 hrs to about 120 hrs; and
e) said cooling is conducted at the same rate as the heating step of step d).

11. The process of claim 9 wherein said ampoule is evacuated to a pressure of about 20 m Torr or less.

12. A process of making a doped 2D multicolor rare earth chalcophosphate crystal comprising:
a) placing raw materials in ampoule comprising quartz, said raw materials being
(i) AgBr, Er, Yb, P and Se in a molar ratio of about 1:0.9:0.1:2:6 to about 1:0.9:0.1:2.5:7; or
(ii) AgBr, Er powder, YbCl₃, P and Se in a molar ratio of about 1:0.9:0.1:2:6 to about 1:0.9:0.1:2.5:7;
b) evacuating the ampoule and then flushing the ampoule with an inert noble gas;
c) sealing the ampoule under vacuum;
d) heating the sealed ampoule to a temperature of from about 580° C. to about 680° C. at a rate of at least 1° C. per hour until said temperature is achieved and holding the ampoule at said temperature for a time of about 50 hrs to about 300 hrs;
e) cooling the ampoule; and
f) scoring the ampoule and removing the contents of said ampoule.

13. The process of claim 12 wherein:
a) said ampoule is a quartz ampoule.
b) said ampoule is evacuated and flushed with an inert gas at least two, three, four five, or even six times;
c) said ampoule is sealed by heating the ampoule;
d) said ampoule is heated to a temperature of from about 600° C. to about 660° C. at a rate of about 20° C. to about 40° C. per hour until said temperature is achieved and the holding the ampoule said temperature for about 72 hrs to about 120 hrs; and
e) said ampoule is cooled to a temperature of from about 20° C. to about 40° C.

14. The process of claim 13 wherein said ampoule is evacuated to a pressure of about 7 mTorr to about 30 mTorr and said cooling is conducted at the same rate as the heating step of step d).

15. The process of claim 12 wherein said ampoule is evacuated to a pressure of about 20 m Torr or less.

16. A method of detecting the presence of one or more chemical agents of interest, said method comprising:
a) placing one or more AgErP₂Se₆ crystals having an emission bandwidth of from about 0.1 nm to about 0.5 nm at 298K for an emission peak of about 660 nanometers, in a region wherein said one or more chemical agents of interest maybe present and measuring the quenching of said one or more AgErP₂Se crystals' emission; and/or
b) placing one or more AgErP₂Se₆ crystals, said AgErP₂Se₆ crystals being doped with a maximum of 10 atomic percent Yb, said AgErP₂Se₆ crystals having an emission bandwidth of from about 0.1 nm to about 0.5 nm at 298K and a photoluminescence emission peaks between 540 and 565 nm at 298K in a region wherein said one or more chemical agents of interest maybe present and measuring the quenching of said one or more AgErP₂Se₆ crystals' emission.

17. The method of claim 16 wherein said one or more AgErP₂Se₆ crystals having an emission bandwidth of from about 0.1 nm to about 0.4 nm at 298K for an emission peak of about 660 nanometers and said one or more AgErP₂Se₆ crystals have an emission bandwidth of from about 0.1 nm to about 0.4 nm at 298K and a photoluminescence emission peaks between 540 and 565 nm at 298K.

18. The method of claim 17 wherein said one or more AgErP₂Se₆ crystals having an emission bandwidth of from about 0.1 nm to about 0.3 nm at 298K for an emission peak of about 660 nanometers and said one or more AgErP₂Se₆ crystals have an emission bandwidth of from about 0.1 nm to about 0.3 nm at 298K and a photoluminescence emission peaks between 540 and 565 nm at 298K.

19. The method of claim 18 wherein said one or more AgErP₂Se₆ crystals having an emission bandwidth of from about 0.1 nm to about 0.2 nm at 298K for an emission peak of about 660 nanometers and said one or more AgErP₂Se₆ crystals having an emission bandwidth of from about 0.1 nm to about 0.2 nm at 298K and a photoluminescence emission peaks between 540 and 565 nm at 298K.

20. The method of claim 16 wherein said AgErP₂Se₆ crystals are doped with 0.1 atomic percent to 10 atomic percent Yb.

21. The method of claim 16 wherein
a) said quenching of said one or more AgErP₂Se₆ crystals' emission is compared to a quenching of emission database for said one or more AgErP₂Se₆ crystals; and/or
b) said quenching of said one or more Yb doped AgErP₂Se₆ crystals' emission is compared to a quenching of emission database for said one or more Yb doped AgErP₂Se₆ crystals.

22. The method of 16, wherein said one or more chemical agents of interest are selected from the group consisting of dimethyl methylphosphonate, 2-chloroethyl ethyl sulfide, methyl salicylate, diethyl malonate, ethyl lactate, malathion, 1,3-dichloropropane, sarin, S-{2-[Di(propan-2-yl)amino]ethyl} O-ethyl methylphosphonothioate, a sulfur mustard, ethyl dimethylphosphoramidocyanidate, a Novichok agent, O-pinacolyl methylphosphonofluoridate and mixtures thereof.
